(19) United States
(12) Patent Application Publication
(10) Pub. No.: US 2024/0311920 A1
(43) Pub. Date: Sep. 19, 2024

(54) Systems and Methods for Intermediating Claim Settlements

(71) Applicant: Yutiva, Inc., Aliso Viejo, CA (US)

(72) Inventor: Neeraj Bhavani, Aliso Viejo, CA (US)

(21) Appl. No.: 18/196,965

(22) Filed: May 12, 2023

Related U.S. Application Data
(60) Provisional application No. 63/452,124, filed on Mar. 14, 2023.

(51) Int. Cl. G06Q 40/08; G06Q 40/02

(52) U.S. Cl. CPC G06Q 40/08; G06Q 40/02

(57) ABSTRACT

A payment processing system is positioned to autonomously intermediate multiple payors, multiple providers, multiple recipients, and multiple banks or other financial institutions. In preferred systems and methods, a computing system is configured to normalize, or at least store, details of the insurance coverage plans, and associate individual plans with individual recipients, insurance and provider codes. Most importantly, the system is also configured to autonomously coordinate communications among the multiple payors, multiple providers, and multiple recipients, and their respective bank or other financial accounts. In especially preferred embodiments, the related transactions are recorded in one or more blockchains.

This application claims the benefit of U.S. Provisional Application No. 63/452,124 filed on Mar. 14, 2023. This and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the invention is processing of insurance claims.

### BACKGROUND

The following description includes information that may be useful in understanding the present invention. It is not an admission that any of the information provided herein is prior art or relevant to the presently claimed invention, or that any publication specifically or implicitly referenced is prior art.

In healthcare and many other industries, involvement of insurance in the payment process induces very significant inefficiencies. Some of the inefficiencies arise due to sheer complexity of interactions among multiple entities, some of the inefficiencies arise due to confidentiality and secrecy requirements of those entities, and some of the inefficiencies arise due to the asynchronous nature of multiple steps involved, including eligibility verification, authorization, adjudication, claims processing, payments, and related reconciliation work.

What is needed is a network solution, configured such that the multiple different business transactions involved in insurance claims processing can be autonomously settled at or near the time of service. This would not only improve the experience and engagement of all the various involved entities, but would remove the waste of expensive manual labor to process and reconcile payments.

### SUMMARY OF THE INVENTION

The inventive subject matter provides systems and methods in which a payment processing system is positioned to autonomously intermediate multiple payors, multiple providers, multiple recipients, and multiple banks or other financial institutions.

In preferred systems and methods, a computing system is configured to normalize, or at least store, details of the insurance coverage plans, and associate individual plans with individual recipients, insurance and provider codes. Most importantly, the system is also configured to autonomously coordinate communications among the multiple payors, multiple providers, and multiple recipients, and their respective bank or other financial accounts. In especially preferred embodiments, the related transactions are recorded in one or more blockchains.

As used herein, the terms “autonomous” and “autonomously” mean operating without requiring human decision making at the level of processing individual claims. This is in contrast to prior art systems that typically involve separate human actions to verify insurance eligibility of a patient or other recipient around the time that a product or service is being provided, authorize the work being performed, processing a charge from the provider, adjudicating the amount to be paid, processing a payment, and reconciling.

### BRIEF DESCRIPTION OF THE DRAWINGS

FIG. 1 is a payment processing system functionally intermediate a payor and a provider with respect to goods or services provided by the provider to a recipient.

### DETAILED DESCRIPTION

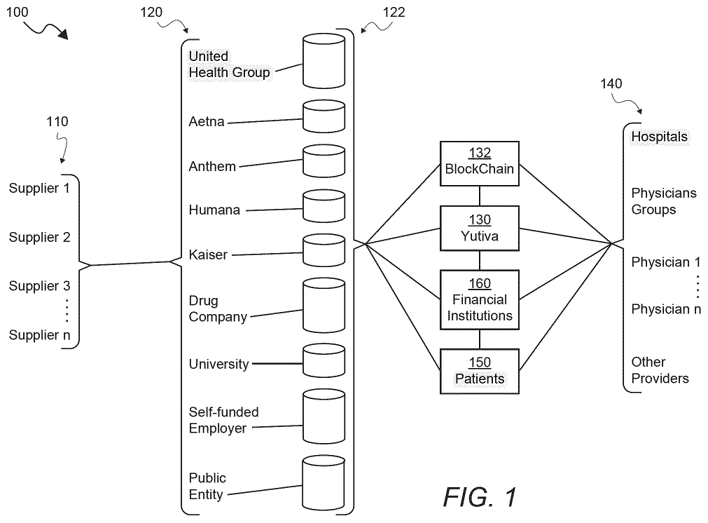

In the exemplary payment processing system 100 depicted in FIG. 1, a computing system 130 is configured to receive (a) identification of patients or other recipients 150, (b) identification of specified insurance plans 122 for which the recipients 150 have coverage; and (c) identification of claims for delivery of goods and/or services provided to the recipients 150 by or on behalf of the providers 140. Upon receipt of the claims, computing system 130 autonomously:
a) accesses eligibility information derived from the stored data to determine eligibility of the recipients 150 with respect to the claims under the specified insurance plans 122;
b) accesses adjudication information derived from the data store to determine amounts to pay to the providers 140 with respect to the claims; and
c) settles the claims by triggering payment of the respective amounts to appropriate accounts 160 on behalf of the providers 140.

In some embodiments, the data stored by computing system 130 includes supplier information, so that payments from the insurance or other payors 120 can be deposited directly in accounts 160 of the suppliers 110.

In medical-related cases, the recipients are typically patients, the providers are typically hospitals, doctors, and physician groups, and the payors are typically insurance companies and other third parties that provide payments to the providers. Accordingly, it should be appreciated that the designations of the payors 120 (United Health Care, Aetna, etc.) and the designations of the providers 140 (Hospitals, Physician Groups, Physicians, etc.) in FIG. 1 are exemplary only, and need not be limited to health care-related entities.

Similarly, block 150 should be interpreted as any recipients, whether patients or otherwise. In non-medical cases, for example, a recipient could comprise an owner of an insured motor vehicle, household appliance, or other device that needs repair or other processing by a provider.

Blockchain 132 should be interpreted as any distributed database or ledger that is shared among the nodes of a computer network, and configured to store data as described herein. Data stored on blockchain 132 can advantageously include details of goods/services provided, including e.g., ICD and CPT/HCPCS Codes, charges, payments amounts from patients, insurance companies, and lenders, and reconciliations among accounts at banks or financial institutions 160.

In FIG. 1, blockchain 132 preferably comprises one or more private blockchains, configured to protect confidential or trade secret information by limiting access to entities with appropriate credentials. For example, one or more chains of blockchain 132 could be configured to prevent one patient's medical records from being accessible by other patients, or unrelated payors or providers. In some contemplated embodiments, the payment processing system 100 can include a first set of interfaces configured for multiple entities to independently add transaction data to the blockchain. In alternative embodiments, the payment processing system 100 could restrict addition of transaction data to additions accomplished through computing system 130. Other interfaces can allow review of information previously stored on blockchain 132, and such review can advantageously be restricted in ways that enforce confidentiality and security. To facilitate such protections, blockchain 132 can advantageously comprise a hyperledger fabric. It is also contemplated that blockchain 132 can provide a real-time network database that can be used for “ChatGPT” or Generative AI capabilities to improve payer-provider-patient communications through chatbots.

An important aspect of payment processing system 100 is that upon receipt of a claim, computing system 130 can autonomously:
a) access eligibility information derived from the stored data to determine eligibility of the recipient 150 with respect to the claim under one or more insurance plans 122;
b) adjudicate the claim to determine amount(s) to pay to one or more providers 140; and
c) settle the claim by triggering payments to appropriate accounts 160 on behalf of the provider(s) 140.

It is especially contemplated that a recipient 150 might not have sufficient funds to cover the charges of a provider 140, even with help from a payor 120. Accordingly, it is contemplated that computing system 130 can be configured to autonomously trigger at least some payment from an account of a lender financial institution 160 to an account on behalf of the provider 140, on behalf of either the recipient 150 or the provider 140.

From another perspective, the current inventor contemplates a method of dis-intermediating settlement of a claim between an insurance payor and a provider with respect to goods or services provided by the provider to a recipient, comprising:
a) providing a data store that correlates (a) coverage rules of the payor for multiple different insurance plans with (b) provider codes/descriptions;
b) using a computing system to receive (a) identification of the recipient, (b) identification of at least a specified one of the insurance plans for which the recipient has coverage; and (c) identification of a claim for delivery of the provided goods or services to the recipient by or on behalf of the provider, and upon receipt of the claim, autonomously:
c) accessing eligibility information derived from the data store to determine eligibility of the recipient with respect to the claim under the specified insurance plan;
d) accessing adjudication information derived from the data store to determine an amount to pay to the provider with respect to the claim; and
e) accessing account information derived from the data store, and settling the claim by triggering a payment of the amount to an account on behalf of the provider, and in some instances another entity.

In preferred embodiments, is triggered payment within 48 hours of receipt of the claim by the computing system. In more preferred embodiments, payment is triggered within 1 hour, still more preferably within 30 minutes, and still more preferably within 5 minutes.

From another perspective payment is preferably triggered within 48 hours of receipt of the provider providing the goods and services to the recipient, more preferably within 1 hour, still more preferably within 30 minutes, and still more preferably within 5 minutes.

It is also contemplated that computing system can be configured to respond to receipt of a claim by identifying to the provider at least one of a claim coding error, a claim submission error, and a credentialing issue.

Throughout this application, the term “computing system” should be interpreted as any suitable combination of servers, services, interfaces, portals, platforms, or other systems formed from one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

It should also be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context.

What is claimed is:

1. A payment processing system functionally intermediate a payor and a provider with respect to goods or services provided by the provider to a recipient, comprising:
a data store correlating (a) coverage rules of the payor for multiple different insurance plans with (b) provider codes/descriptions;
an interface configured to update the coverage rules on the data store;
a computing system configured to receive (a) identification of the recipient, (b) identification of at least a specified one of the insurance plans for which the recipient has coverage; and (c) identification of a claim for delivery of the provided goods or services to the recipient by or on behalf of the provider, and upon receipt of the claim, to autonomously:
access eligibility information derived from the data store to determine eligibility of the recipient with respect to the claim under the specified insurance plan;
adjudicate the claim to determine amounts to pay to one or more providers; and
settle the claim by triggering payments to appropriate accounts on behalf of the provider(s).

2. The payment processing system of claim 1, further comprising a blockchain distinct from the data store, and configured to store a block containing details of the claim and the payment.

3. The payment processing system of claim 2, further comprising a provider interface configured to add the claim to the blockchain.

4. The payment processing system of claim 2, wherein the blockchain comprises a hyperledger fabric.

5. The payment processing system of claim 2, wherein the blockchain is configured to restricts a competitor to from accessing the portion of the blockchain storing the block.

6. The payment processing system of claim 1, wherein the computing system is further configured to trigger at least some of the payment from a lender to the account on behalf of the provider.

7. A method of dis-intermediating settlement of a claim between an insurance payor and a provider with respect to goods or services provided by the provider to a recipient, comprising:
providing a data store that correlates (a) coverage rules of the payor for multiple different insurance plans with (b) provider codes/descriptions;
using a computing system to receive (a) identification of the recipient, (b) identification of at least a specified one of the insurance plans for which the recipient has coverage; and (c) identification of a claim for delivery of the provided goods or services to the recipient by or on behalf of the provider, and upon receipt of the claim, autonomously:
accessing eligibility information derived from the data store to determine eligibility of the recipient with respect to the claim under the specified insurance plan;
accessing adjudication information derived from the data store to determine an amount to pay to the provider with respect to the claim; and
settling the claim by triggering a payment of the amount to an account on behalf of the provider.

8. The method of claim 7, further comprising using a blockchain distinct from the data store to store a block containing details of the claim and the payment.

9. The method of claim 7, further comprising triggering the payment within 48 hours of receipt of the claim by the computing system.

10. The method of claim 7, further comprising triggering the payment within 48 hours of the provider providing the goods and services to the recipient.

11. The method system of claim 7, wherein the coverage rules include a correlation between an ICD code and a CPT code.

12. The method system of claim 7, further comprising the computing system responding to receipt of the claim by identifying to the provider at least one of a claim coding error, a claim submission error, and a credentialing issue.

13. The method system of claim 7, wherein the adjudication information comprises at least one of a coinsurance amount, a deductible, and a benefit maximum.

14. The method system of claim 7, wherein the payor comprises a medical insurance company.

15. The method system of claim 7, wherein the payor comprises a self-funded employer

16. The method system of claim 7, wherein the payor comprises a payor comprises a second provider.

17. The method system of claim 7, wherein the provider comprises at least a medical care entity and a medical professional.

18. The method system of claim 7, wherein the recipient comprises a patient.

19. The method system of claim 7, wherein the recipient comprises an owner of a device insured against damage.
